(19) United States
(12) Patent Application Publication
(10) Pub. No.: US 2022/0044109 A1
(43) Pub. Date: Feb. 10, 2022

(54) QUANTIZATION-AWARE TRAINING OF QUANTIZED NEURAL NETWORKS

(71) Applicant: Waymo LLC, Mountain View, CA (US)

(72) Inventor: Paul Donnelly, San Jose, CA (US)

(21) Appl. No.: 16/987,163

(22) Filed: Aug. 6, 2020

(51) Int. Cl. G06N 3/08

(52) U.S. Cl. CPC G06N 3/08; G06N 5/046

(57) ABSTRACT

Methods, systems, and apparatus, including computer programs encoded on computer storage media, for training a quantized neural network. One of the methods includes, for each of a plurality of neural network layers and at each of a plurality of training time steps: receiving an input tensor for the neural network layer; processing the input tensor using the neural network layer to generate an output tensor, wherein the output tensor has a first precision; obtaining a current quantization range for output tensors of the neural network layer; processing the output tensor using the current quantization range to generate a quantized output tensor that has a second precision that is lower than the first precision; determining an error between the output tensor and the quantized output tensor; and determining an update to the quantization range using the determined error.

### BACKGROUND

This specification relates to generating outputs using neural networks.

Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values. Once a neural network is trained, the final set of parameter values can be used to make predictions in a production system.

### SUMMARY

This specification describes a system that trains quantized neural networks. In this specification, a quantized neural network is a neural network that has one or more quantized neural network layers. A quantized neural network layer is a neural network layer that reduces the precision of activation tensors, weight tensors, or both, relative to how the tensors are stored or received. By performing operations on tensors that have a lower precision, the quantized neural network layer can increase efficiency and improve performance of the neural network at inference time.

In particular, in this specification a quantized neural network layer is a neural network layer that processes an input tensor and a weight tensor to generate an activation tensor having a first precision, and then “quantizes” the activation tensor to generate an output tensor having a second precision that is smaller than the first precision. For example, the first precision can be 8-bit precision, and the second precision can be 32-bit precision. That is, the quantized neural network layer processes the activation tensor having the second precision in order to generate an output tensor that is a lower-precision approximation of the activation tensor.

In some cases, the input tensor and weight tensor have the second, lower precision; in some other cases, the input tensor and weight tensor have the first, higher precision; in yet other cases, the input tensor and/or weight tensor might have a third precision that is different from the first precision and the second precision. That is, the input tensor, weight tensor, activation tensor, and output tensor can all have different precision; the only requirement is that the output tensor has a lower precision than the activation tensor.

In this specification, a tensor is an ordered collection of numeric values. For example, a tensor can be a vector, matrix, or multi-dimensional matrix of floating point or other numeric values.

During training of a quantized neural network, for each quantized neural network layer in the quantized neural network, the system can determine an optimal quantization range for quantizing the activation tensor generated by the quantized neural network layer. The system can determine these optimal quantization ranges in parallel with determining trained values for the weight tensors of the quantized neural network. In particular, at each of multiple training time steps, the system can quantize the activation tensor according to a current quantization range to generate a quantized activation tensor, and determine an error between the activation tensor and the quantized activation tensor. The system can then determine an update to the current quantization range using the determined error, e.g., by performing gradient descent.

The subject matter described in this specification can be implemented in particular embodiments so as to realize one or more of the following advantages.

Quantized neural networks can enjoy greatly improved efficiency compared to unquantized neural networks. This improved efficiency can be very important in applications that require outputs from the neural network with little latency, e.g., autonomous driving applications where an autonomous vehicle must make driving decisions in real time; when the neural network is deployed on devices that have limited available computations resources; or both.

Quantization is a technique for modifying a neural network in order to allow the neural network to be deployed on specific kinds of hardware devices and computing environments. In particular, quantized neural networks can be deployed on specialized hardware that is incompatible with unquantized neural networks, e.g., field programmable gate arrays (FPGAs) or application-specific integrated circuits (ASICs) configured for low-precision operations. As a particular example, an 8-bit tensor processing unit (TPU) can execute the low-precision operations of a quantized neural network in a highly efficient and parallelized manner, and thus can generate outputs more quickly than hardware that is compatible with unquantized neural networks. Furthermore, the operations of a quantized neural network can be executed on hardware that is too resource-constrained to execute the operations of an unquantized neural network, e.g., hardware with a limited memory. Therefore, the quantized neural network can be deployed onto devices that have limited resources, e.g., mobile devices.

Furthermore, after training a neural network, often the higher precision provided by unquantized tensors is unnecessary for precisely detecting and representing the presence or absence of important features within input examples. That is, by quantizing the activation tensors, error introduced by quantization, and therefore the cost of precision of quantizing the activation tensors, is minimal compared to the efficiency gains.

As a particular example, quantizing from 32-bit tensors to 8-bit tensors can cause a reduction in the accuracy of the network output of the neural network of 0 to 0.5%. On the other hand, the storage and bandwidth cost of the neural network is reduced by 4×. In fact, the error introduced by quantization can often be overcome by introducing one or a few additional quantized neural network layers to the quantized neural network, so that the accuracy of the network output is not reduced (and can even be improved) while the efficiency is still improved by almost 4× and the memory cost is still reduced by almost 4×. Therefore, performing quantization can lead to improved accuracy of the neural network with no efficiency or memory tradeoffs at all.

Using techniques described in this specification, a system can learn optimal values for the quantization range for each quantized neural network layer of a quantized neural network. Some existing techniques determine the quantization range by processing training examples and tabulating, for each neural network layer, the maximum and minimum elements observed across the training examples. Some other existing techniques tabulate, for each neural network layer, a rolling average of the maximum value and a rolling average of the minimum value observed across the training examples. These existing techniques do not learn the optimal quantization range that minimizes the error introduced during quantization, as the optimal quantization range is often not equal to the range between the maximum and minimum values observed during training. Instead, as described below, often a smaller quantization window is optimal, to reduce the error introduced by elements in between values in the quantization range, while not significantly increasing the error introduced by outlier elements outside of the quantization range. Systems described in this specification can machine learn this optimal quantization range. That is, by machine learning the quantization range, a system can deploy a quantized neural network that generates network outputs at inference time that are more accurate than the network outputs of quantized neural networks whose quantization range has been determined using conventional techniques. Furthermore, the improved accuracy does not increase the memory or computational cost of executing the operations of the quantized neural network. That is, the higher-accuracy quantized neural network described in this specification can be deployed on hardware with the same resource constraints as hardware that supports existing quantized neural networks, and can be executed with similar time and computational efficiency.

In some implementations, techniques described in this specification can determine, for each quantized neural network layer, a different optimal quantization range for each element of the activation tensor of the layer, as opposed to a single quantization range that applies to every element in the activation tensor. Some existing techniques determine quantization ranges by maintaining a histogram of elements observed across multiple examples, and determining the quantization range according to the histogram. However, it is often not feasible to maintain a separate histogram for each element of each activation tensor in the neural network, as the memory cost is too high. Therefore, these existing techniques are generally unable to determine different quantization ranges for each element of each activation tensor. Quantized neural networks that use a different quantization range for each element of an activation tensor can generate network outputs that are more accurate than quantized neural networks that use a single quantization range for the activation tensor; thus some systems described in this specification can deploy a quantized neural network that is more accurate than quantization neural networks trained using some existing techniques. Furthermore, maintaining a different quantization range for each element of an activation tensor does not significantly increase the memory and computational resources required to execute the quantized neural network. That is, the quantization neural network that use a different quantization range for each element of an activation tensor can be deployed onto hardware with similar resource constraints as hardware that supports quantized neural networks that use a single quantization range for the activation tensor, and can be executed at inference time with similar time and computational efficiency.

Furthermore, in some implementations, techniques described in this specification can determine a different optimal quantization range for each of multiple channels of the activation tensor, e.g., each channel of the activation tensor of a convolutional neural network layer. This provides a compromise between the greater precision of per-element quantization range and the greater efficiency of a single quantization range.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example quantized neural network layer.

FIG. 2 is a diagram of an example training engine for updating a quantization range of a quantized neural network layer.

FIG. 3 is a flow diagram of an example process for training a quantized neural network layer.

FIG. 4 is a flow diagram of an example process for determining an update to a quantization range of a quantized neural network layer.

Like reference numbers and designations in the various drawings indicate like elements.

### DETAILED DESCRIPTION

This specification describes a system that trains a quantized neural network. Each of one or more quantized neural network layers of the quantized neural network can process the activation tensor generated by the quantized neural network layer to output a quantized activation tensor that has a lower precision than the original activation tensor. In particular, in parallel with determining trained values for the weight parameters of the quantized neural network, a training system for the quantized neural network can determine, for each quantized neural network layer, an optimal quantization range for quantizing the activation tensors of the layer.

In order to quantize a tensor to generate a quantized tensor, a system can maintain a quantization range that represents a range of possible values that the elements of the quantized tensor can take. Given a particular precision, there is a finite number of values that a tensor can take. For example, an 8-bit tensor can include elements that take 2⁸=256 different possible values, while a 32-bit tensor can include elements that take 2³²=4,294,967,296 different possible values. The set of possible values that elements of a particular precision can take can be defined by a minimum value and a maximum value, where the other values in the set of possible values are evenly spaced between the minimum value and the maximum value. For example, the set of possible values taken by elements of an 8-bit tensor might be [0,255]; i.e., the minimum value is 0, the maximum value is 255, and the other values are spaced in increments of 1 between 0 and 255. As another example, the set of possible values taken by elements of an 8-bit tensor might be [0,1020]; i.e., the minimum value is 0, the maximum value is 1020, and the other values are spaced in increments of 4 between 0 and 1020.

For a particular precision, if a given value is not in the set of possible values that can be taken by the elements of a tensor of the particular precision, then the given value must be approximated by the closest possible value in the set. For example, for an 8-bit tensor whose set of possible element values is [0,255], the values 254.9, 256, and 265 (none of which are in the set of possible values) would all be approximated by an element representing the value 255 (which is in the set of possible values). These approximations have an error of 0.1, 1, and 10, respectively.

When a system quantizes a tensor to generate a quantized tensor, the system reduces the number of possible values that elements of the quantized tensor can take. For example, when quantizing a 32-bit tensor, the system assigns each element in the tensor (which previously was assigned to one out of 4,294,967,296 different possible values) to one out of 256 different possible values. That is, each possible value in the quantized tensor corresponds to 2²⁴=16,777,216 different possible values in the original tensor. Therefore, quantizing a tensor can introduce error in the elements of the tensor. The goal of a system that performs quantization is to minimize this error, i.e., to select a quantization range for possible values of the elements of the quantized tensor that minimizes the error introduced by quantization.

The error introduced by quantizing can be categorized into two types: error introduced by elements in between possible values in the quantization range, and error introduced by elements outside of the quantization range. For example, a system might quantize an 8-bit tensor whose set of possible element values is [0, 255] with values spaced at increments of 1, generating a quantized 4-bit tensor whose set of possible element values is [0, 240] with values spaced at increments of 16. An element of the original 8-bit tensor whose value is 11 would correspond to an element of the quantized 4-bit tensor whose value is 16, introducing an error of 5; this represents an error introduced by an element that is in between possible values in the quantization range of the quantized 4-bit tensor. An element of the original 8-bit tensor whose value is 250 would corresponds to an element of the quantized 4-bit tensor whose value is 240, introducing an error of 10; this represents an error introduced by an element that is outside of the quantization range of the quantized 4-bit tensor. In order to minimize the total error introduced by quantization, a system that performs quantization must balance both types of error, selecting a quantization range that is not so small that elements outside of the quantization range introduce a lot of error, and not so large that elements in between possible values in the quantization range introduce a lot of error.

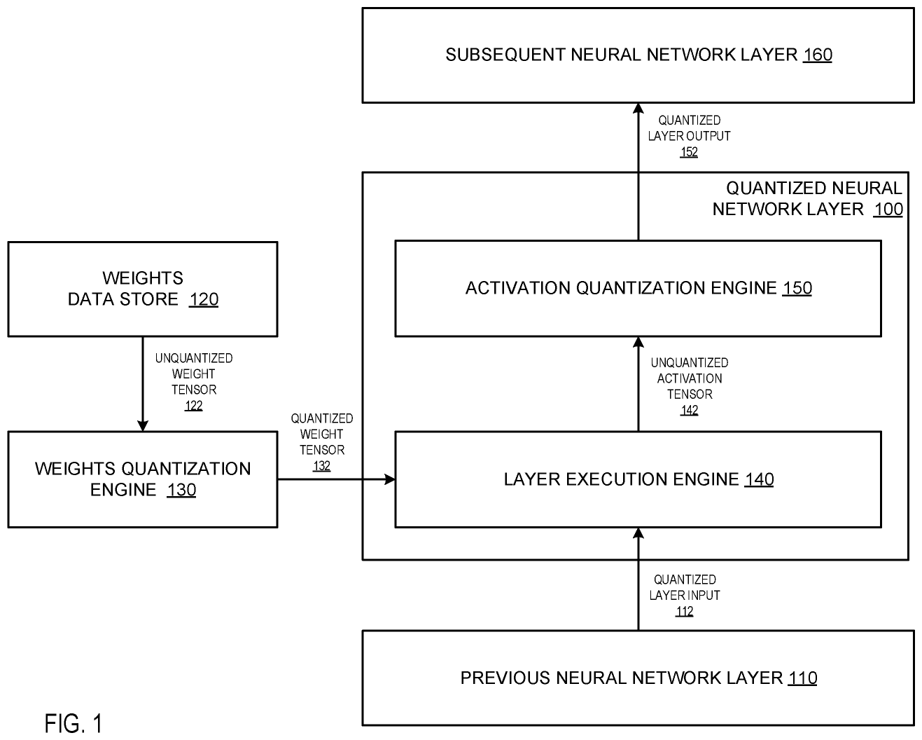

FIG. 1 is a diagram of an example quantized neural network layer 100 of a quantized neural network. The quantized neural network layer 100 is an example of a system implemented as computer programs on one or more computers in one or more locations, in which the systems, components, and techniques described below can be implemented.

The parameters of the quantized neural network layer 100 can be trained, i.e., the quantized neural network layer 100 can be a component of an inference system configured to execute the trained quantized neural network, or untrained, i.e., the quantized neural network layer 100 can be a component of a training system configured to train the quantized neural network.

The quantized neural network can be configured to perform any machine learning task. For example, the quantized neural network can be a feedforward neural network that is configured to process a network input to generate a network output, e.g., a classification output that includes a respective score corresponding to each of multiple categories for the network input. As another example, the quantized neural network can be a recurrent neural network that is configured to process an input sequence having multiple input elements to generate a network output having multiple output elements, e.g., a machine translation neural network or a speech synthesis neural network. As another example, the quantized neural network can be configured to process an input that includes an image to generate a corresponding output, e.g., a classification output, a regression output, or a combination thereof.

As a particular example, the quantized neural network can be configured to process an image to generate a classification output that includes a respective score corresponding to each of multiple categories. The score for a category indicates a likelihood that the image belongs to the category. In some cases, the categories may be classes of objects (e.g., dog, cat, person, and the like), and the image may belong to a category if it depicts an object included in the object class corresponding to the category. In some cases, the categories may represent global image properties (e.g., whether the image depicts a scene in the day or at night, or whether the image depicts a scene in the summer or the winter), and the image may belong to the category if it has the global property corresponding to the category.

As another particular example, the quantized neural network can be configured to process an image to generate a pixel-level classification output that includes, for each pixel, a respective score corresponding to each of multiple categories. For a given pixel, the score for a category indicates a likelihood that pixel belongs to the category. In some cases, the categories may be classes of objects, and a pixel may belong to a category if it is part of an object included in the object class corresponding to the category. That is, the pixel-level classification output may be semantic segmentation output.

As another particular example, the quantized neural network can be configured to process an image to generate a regression output that estimates one or more continuous variables (i.e., that can assume infinitely many possible numerical values) that characterize the image. In a particular example, the regression output may estimate the coordinates of bounding boxes that enclose respective objects depicted in the image. The coordinates of a bounding box may be defined by (x, y) coordinates of the vertices of the bounding box.

Referring to FIG. 1, the quantized neural network layer 100 is configured to receive a layer input 112 from a previous neural network layer 110 in the quantized neural network.

In some cases, the layer input 112 has a first precision (e.g., 8-bit precision) that is lower than a second precision (e.g., 32-bit precision). For example, the previous neural network layer 110 might be a quantized neural network layer, i.e., might have generated an activation tensor having the second precision and then quantized the activation tensor to generate the layer input 112.

In some other cases, the layer input 112 has the second precision that is higher than the first precision. For example, the first neural network layer, or the first few neural network layers, of a quantized neural network is sometimes unquantized; that is, the first neural network layer often generates layer outputs that have the second, higher precision. Therefore, the first quantized neural network layer of the quantized neural network must receive inputs that have the second, higher precision and generate outputs that have the first, lower precision.

In other words, the quantized neural network layer 100 receives a layer input 112 and generates a layer output 152 that has the first, lower precision. In some cases, the layer input 112 also has the first precision; in some other cases, the layer input 112 has the second precision; and in yet some other cases, the layer input 112 has a third precision that is different from both the first precision and second precision. The below description will refer to the layer input 112 as having the first precision, and thus the layer input 112 is called the “quantized” layer input 112. However, it is to be understood that, in general, the layer input 112 can have any precision.

The quantized neural network layer 100 includes a layer execution engine 140 and an activation quantization engine 150.

The layer execution engine 140 is configured to receive the quantized layer input 112 and to process the quantized layer input 112 to generate an unquantized activation tensor 142 having the second precision. In order to process the quantized layer input 112, the layer execution engine 140 obtains a weight tensor 132.

Similar to the layer input 112, in some cases the weight tensor 132 has the first precision; in some other cases, the weight tensor 132 has the second precision; in yet some other cases, the weight tensor 132 has a third precision that is different from both the first precision and the second precision. The below description will refer to the weight tensor 132 as having the first precision, and thus the weight tensor 132 is called the “quantized” weight tensor 132. However, it is to be understood that, in general, the layer input 112 can have any precision.

Referring to the case, where the weight tensor 132 has the first precision, often during training, a training system for the quantized neural network will maintain weight tensors for each quantized neural network layer that have the second, higher precision. This allows the training system to determine more precise updates to the weight tensors, improving training. After training is completed and the quantized neural network is deployed, often the deployed system will only maintain quantized versions of the trained weight tensors.

That is, during training of the quantized neural network, a weights data store 120 can store an unquantized weight tensor 122 having the second precision. A weights quantization engine 130 can obtain the unquantized weight tensor 122 and quantize it to generate the weight tensor 132 having the first precision. Thus, the weight tensor 132 is called the “quantized” weight tensor 132.

Because the weights quantization engine 130 can directly observe every value in the unquantized weight tensor 122, quantizing the unquantized weight tensor 122 can be straightforward. This is not the case for quantizing the unquantized activation tensor 142, because the quantized neural network layer 100 is provided a quantized layer input 112 that is sampled from an unknown distribution of quantized layer inputs 112 that the layer 100 might receive; this distribution is itself dependent on i) an unknown distribution of network inputs to the quantized neural network, and ii) the yet-untrained weight tensors of previous layers in the quantized neural network. Therefore, the quantized neural network 100 does not have access to the true range of values that the elements of the unquantized activation tensor 142 will take. Therefore, the optimal quantization range for the layer 100 can be learned during training.

Referring back to FIG. 1, the layer execution engine 140 processes the quantized layer input 112 using the quantized weight tensor 132 to generate the unquantized activation tensor 142. This processing includes every operation that the quantized neural network layer 100 will perform during inference. As a particular example, if the layer 100 is a feedforward neural network layer, then the layer execution engine 140 might multiply the quantized layer input 112 and the quantized weight tensor 132 and, optionally, add a bias vector to the product to generate an initial activation tensor, and then process the initial activation tensor using an activation function, e.g., the TanH or ReLU function, to generate the unquantized activation tensor 142. As another particular example, if the layer 100 is a convolutional neural network layer, then the layer execution engine 140 might convolve the quantized layer input 112 using the quantized weight tensor 132 to generate a first activation tensor, then process the first activation tensor using Batch Normalization to generate a second activation tensor, and then process the second activation tensor using an activation function to generate the unquantized activation tensor 142.

Importantly, the activation tensor 142 can have the second precision even though the weight tensor 132 and the layer input 112 both have the first precision. For example, computing the product of two tensors having an 8-bit precision can generate a tensor having a 16-bit precision, and summing multiple 16-bit tensors can generate a tensor having a 32-bit precision.

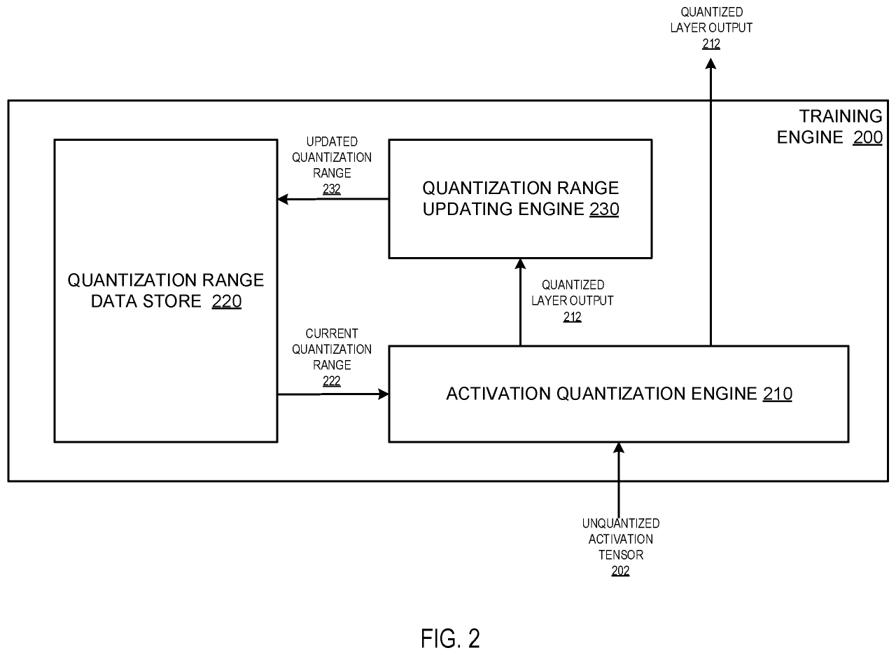

The activation quantization engine 150 is configured to receive the unquantized activation tensor 142 and to process the unquantized activation tensor 142 to generate the quantized layer output 152. In particular, the activation quantization engine 150 quantizes the unquantized activation tensor 142 according to current values of the quantization range of the quantized neural network layer 100. This process is described in more detail below with respect to FIG. 2. The quantized neural network layer 100 can then provide the quantized layer output 152 to a subsequent neural network layer 160 in the quantized neural network.

After the activation quantization engine 150 generates the quantized layer output 152, the training system can determine an error between the quantized layer output 152 and the unquantized activation tensor 142, and use the error to determine an update to the quantization range of the quantized neural network layer 100. That is, by repeatedly updating the quantization range during training of the quantized neural network, the training system can determine the optimal quantization range that will be used at inference time after the quantized neural network is deployed. This process is described in more detail below with respect to FIG. 2. In some implementations, the training system updates the quantization range of the quantized neural network layer 100 concurrently with determining updates to the weight tensors of the quantized neural network layer 100.

FIG. 2 is a diagram of an example training engine 200 for updating a quantization range of a quantized neural network layer, e.g., the quantization neural network layer 100 depicted in FIG. 1. The training engine 200 is an example of a system implemented as computer programs on one or more computers in one or more locations, in which the systems, components, and techniques described below can be implemented.

The training engine 200 includes an activation quantization engine 210, a quantization range data store 220, and a quantization range updating engine 230.

The quantized neural network layer 210 is configured to receive an unquantized activation tensor 202 and to quantize the unquantized activation tensor 202 to generate a quantized layer output 212 for the neural network layer that has a precision that is lower than the precision of the unquantized activation tensor 202. For example, the activation quantization engine 210 can be the activation quantization engine 150 depicted in FIG. 1. The unquantized activation tensor 202 corresponds to a training example that the quantized neural network is processing to train the weight parameters of the quantized neural network.

The quantization range data store 220 is configured to store current parameters 222 for the quantization range of the quantized neural network layer, i.e., the range of possible values that elements of the quantized layer output 212 can take.

In some implementations, the quantization range is defined by two scalar values: a minimum value that elements of the quantized layer output 212 can take, and a maximum value that elements of the quantized layer output 212 can take. That is, in some implementations, each element of the quantized layer output 212 must take a value from the same set of possible values defined by the minimum value and maximum value.

In some other implementations, the quantization range is defined by 2N scalar values, where N is the number of channels of the quantized layer output 212. Each channel has a minimum and maximum value that elements of the channel of the quantized layer output 212 can take. That is, in some implementations, each element of a particular channel of the quantized layer output 212 must take a value from the set of possible values corresponding to the particular channel and defined by the corresponding minimum value and maximum value.

In some other implementations, the quantization range is defined by two tensors of the same size as the quantized layer output 212: a minimum tensor and a maximum tensor. The minimum tensor defines, for each element of the quantized layer output 212, the minimum scalar value that the element can take. The maximum tensor defines, for each element of the quantized layer output 212, the maximum scalar value that the element can take. That is, in some implementations, the parameters 222 for the quantization range of the quantized neural network layer can define, for each element of the quantized layer output 212, a different quantization range.

To quantize the unquantized activation tensor 202, the activation quantization engine 210 obtains the current parameters 222 of the quantization range. In the implementations in which the current parameters 222 define a single quantization range for each element of the quantized layer output 212, the activation quantization engine 210 can quantize each element of the unquantized activation tensor 202 to be within that single quantization range. In the implementations in which the current parameters 222 define a different quantization range for each channel of the quantized layer output 212, the activation quantization engine 212 can quantize each element of each channel of the unquantized activation tensor 202 to be within the respective quantization range corresponding to the channel. In the implementations in which the current parameters 222 define a different quantization range for each element of the quantized layer output 212, the activation quantization engine 212 can quantize each element of the unquantized activation tensor 202 to be within the respective quantization range corresponding to the element. The activation quantization engine 210 then quantizes the unquantized activation tensor 202 by processing each element of the unquantized activation tensor 202 to be within the current quantization range 222. That is, for each element, the activation quantization engine 210 determines the closest value in the set of values that the element can take, as defined by the current quantization range 222, and represents the element using the determined closest value in the quantized layer output 212.

After generating the quantized layer output 212, the activation quantization engine 210 can provide the quantized layer output 212 to a subsequent neural network layer in the quantized neural network, e.g., the subsequent neural network layer 160 depicted in FIG. 1. The activation quantization engine 210 can also provide the quantized layer output 212 to the quantization range updating engine 230.

The quantization range updating engine 230 determines an error between the quantized layer output 212 and the unquantized activation tensor 202.

In the implementations in which there is a single quantization range that applies to each element of the quantized layer output 212, the error can be a scalar error that characterizes a combined error of each element of the quantized layer output 212. For example, the quantization range updating engine 230 can determine an error for each element and compute a sum or average of the errors.

In the implementations in which there is a different quantization range corresponding to each channel of the quantized layer output 212, the error can be a tensor of the same size as the number of channels in the quantized layer output 212 that characterizes, for each channel of the quantized layer output 212, a respective error of the channel.

In the implementations in which there is a different quantization range corresponding to each respective element of the quantized layer output 212, the error can be a tensor of the same size as the quantized layer output 212 that characterizes, for each element of the quantized layer output 212, a respective error of the element.

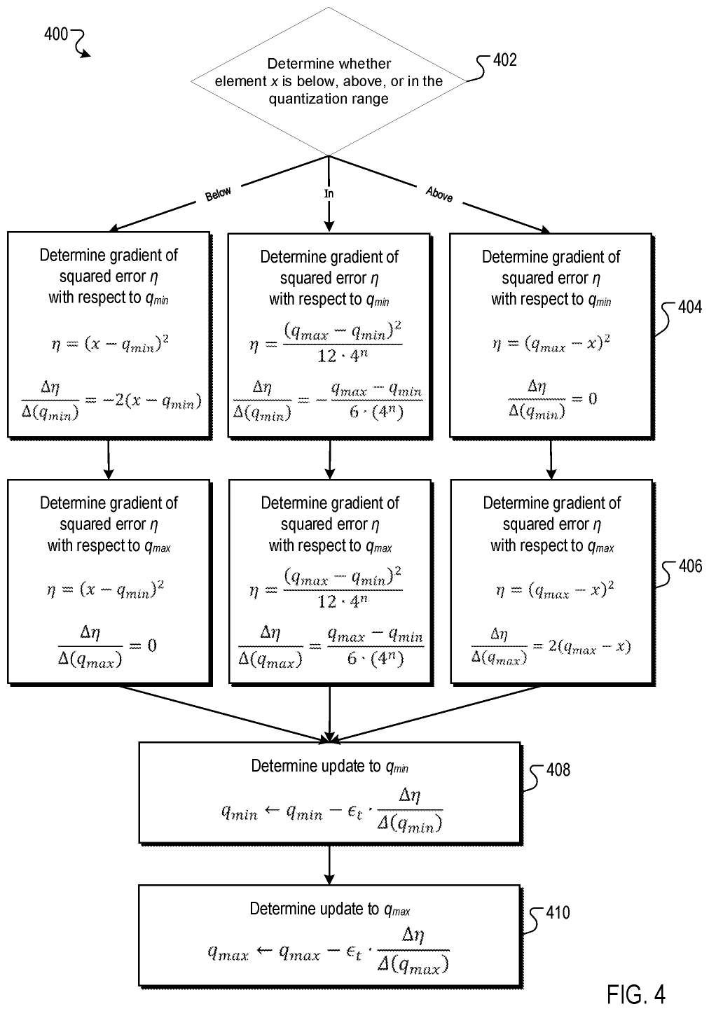

In some implementations, the error is an exact error introduced during quantization; that is, the quantization range updating engine 230 exactly computes a difference between the values of the quantized layer output 212 and the values of the unquantized activation tensor 202. In some other implementations, the error is an estimated error introduced during quantization; an example process for estimating the error is discussed below with respect to FIG. 4.

The quantization range updating engine 230 can use the determined error to determine an update 232 to the quantization range. In the implementations in which there is a single quantization range that applies to each element of the quantized layer output 212, the quantization range updating engine 230 can determine an update to the single minimum value and the single maximum value of the quantization range. In the implementations in which there is a different quantization range corresponding to each channel of the quantized layer output 212, the quantization range updating engine 230 can determine, for each channel of the quantized layer output 212, an update to the respective minimum and maximum values in the quantization range of the channel. In the implementations in which there is a different quantization range corresponding to each respective element of the quantized layer output 212, the quantization range updating engine 230 can determine, for each element of the quantized layer output 212, an update to the respective minimum and maximum values in the quantization range of the element.

For example, the quantization range updating engine 230 can use gradient descent to update the quantization range. That is, the quantization range updating engine 230 can determine a gradient of the determined error with respect to the minimum value, and determine an update to the minimum value by subtracting the gradient from the minimum value, optionally weighted by a step size. Similarly, the quantization range updating engine 230 can determine a gradient of the determined error with respect to the maximum value, and determine an update to the maximum value by subtracting the gradient from the maximum value, optionally weighted by a step size.

In some implementations, the training engine 200 determines an update 232 to the quantization range after the quantized neural network layer processes each training example. In some other implementations, the training engine 200 processes a batch of training examples, determines an error corresponding to each training example, and then determines the update 232 to the quantization range 232 according to a combined error across the batch of training examples, e.g., an average error.

The quantization range updating engine 230 provides the updated quantization range 232 to the quantization range data store 220, for use to quantize future unquantized activation tensors 202.

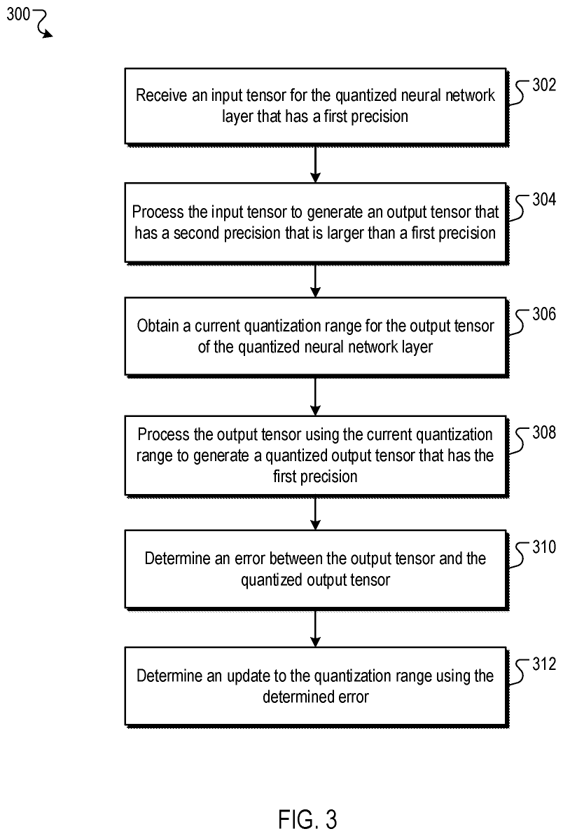

FIG. 3 is a flow diagram of an example process 300 for training a quantized neural network layer. For convenience, the process 300 will be described as being performed by a system of one or more computers located in one or more locations. For example, a training engine, e.g., the training engine 200 depicted in FIG. 2, appropriately programmed in accordance with this specification, can perform the process 300.

The system can perform the process 300 for each of one or more quantized neural network layers of the quantized neural network at each of one or more training time steps. The system receives an input tensor for the quantized neural network layer that has a first precision (step 302).

The system processes the input tensor using the quantized neural network to generate an output tensor that has a second precision that is larger than the first precision (step 304).

For example, the system can obtain a weight tensor for the quantized neural network layer that has the second precision, and quantize the weight tensor to generate a quantized weight tensor that has the first precision. For example, the system can determine a minimum weight value and a maximum weight value for elements of the weight tensor, and determine the quantization range of the quantized weight tensor to be the range between the minimum weight value and the maximum weight value. The system can then process the input tensor and the quantized weight tensor to generate the output tensor.

The system obtains a current quantization range for the output tensor of the quantized neural network layer (step 306).

In some implementations, the quantization range for output tensors of the quantized neural network layer is defined by a minimum scalar value and a maximum scalar value. That is, the system quantizes each element of the output tensor according to the same range of scalar values.

In some other implementations, the quantization range for output tensors of the neural network layer is defined by a minimum tensor and a maximum tensor, where the minimum tensor and maximum tensor have the same number of elements as the number of channels of the neural network layer. That is, the system quantizes the elements of each channel of the output tensor according to a different respective range of scalar values.

In some other implementations, the quantization range for output tensors of the neural network layer is defined by a minimum tensor and a maximum tensor, where the minimum tensor and maximum tensor have the same number of elements as the output tensors of the neural network layer. That is, the system quantizes each element of the output tensor according to a different respective range of scalar values.

The system processes the output tensor using the current quantization range to generate a quantized output tensor that has the first precision (step 308).

The system determines an error between the output tensor and the quantized output tensor (step 310). The system can determine, for each element of the output tensor, an element error between the element of the output tensor and the corresponding element of the quantized output tensor. In some implementations, each element error is an exact error between the output tensor and the corresponding element of the quantized output tensor. In some other implementations, one or more element errors are an estimated error between output tensor and the corresponding element of the quantized output tensor.

The system determines an update to the quantization range using the determined error (step 312). For example, the system can determine an update to the quantization range using gradient descent. This process is described in more detail below with respect to FIG. 4.

FIG. 4 is a flow diagram of an example process 400 for determining an update to a quantization range of a quantized neural network layer. For convenience, the process 400 will be described as being performed by a system of one or more computers located in one or more locations. For example, a training engine, e.g., the training engine 200 depicted in FIG. 2, appropriately programmed in accordance with this specification, can perform the process 400.

The system can perform the process 400 for each element x of an unquantized tensor that has been quantized by the quantized neural network layer to generate a corresponding quantized tensor. In some implementations, the system can perform the process 400 for each element x of the quantized tensor in parallel.

The system determines whether the element x of the unquantized tensor is below, above, or in the quantization range of the quantized neural network layer (step 402). The quantization range is defined by a minimum scalar value qₘᵢₙ and a maximum scalar value qₘₐₓ. Therefore, the element x is below the quantization range if x<qₘᵢₙ, above the quantization range if x>qₘₐₓ, and in the quantization range if qₘᵢₙ≤x≤qₘₐₓ.

In some implementations, the values qₘᵢₙ and qₘₐₓ are the same for each element of the unquantized tensor; that is, each element x of the unquantized tensor has been quantized according to the same range of scalar values. In some other implementations, the values qₘᵢₙ and qₘₐₓ are unique to the channel of the element x; that is, the elements of each channel of the unquantized tensor has been quantized according to a different respective range of scalar values. In some other implementations, the values qₘᵢₙ and qₘₐₓ are unique to the element x; that is, each element of the unquantized tensor has been quantized according to a different respective range of scalar values.

Referring to the case where the element x is below the quantization range:

The system determines (step 404) the gradient of a squared error η introduced by quantizing element x, with respect to qₘᵢₙ. In this case, the squared error η introduced by quantizing element x is:

η=(x−qₘᵢₙ)²,

where the error is equal to the amount by which x is below the minimum value qₘᵢₙ.

Thus, the gradient of η with respect to qₘᵢₙ is:

$$\frac{Δ η}{Δ {q}_{min}} = - 2 ( x - {q}_{min} )$$

The system determines (step 408) the gradient of η with respect to qₘₐₓ:

$$\frac{Δ η}{Δ {q}_{max}} = 0$$

Note that the system does not necessarily have to compute the squared error η itself, because the system only used the gradient of the squared error η when updating the minimum and maximum values.

Referring to the case where the element x is above the quantization range:

The system determines (step 404) the gradient of the squared error η introduced by quantizing element x, with respect to qₘᵢₙ. In this case, the squared error η introduced by quantizing element x is:

η=(qₘₐₓ−x)²,

where the error is equal to the amount by which x is above the maximum value qₘₐₓ.

Thus, the gradient of η with respect to qₘᵢₙ is:

$$\frac{Δ η}{Δ {q}_{min}} = 0$$

The system determines (step 408) the gradient of η with respect to qₘₐₓ:

$$\frac{Δ η}{Δ {q}_{max}} = 2 ( {q}_{max} - x )$$

Referring to the case where the element x is in the quantization range:

The system determines (step 404) the gradient of the squared error η introduced by quantizing element x, with respect to qₘᵢₙ.

Exactly calculating the error for each element x that is inside the quantization range can be computationally expensive. Therefore, the system can use an approximation by assuming that the elements x that are inside the quantization range are evenly distributed within the quantization range. Because most of the elements will be inside the quantization range, this is a reasonable assumption to make. Then, the system can compute the expected value of the squared error η, and treat the expected value as if it is the true η. Note that the expected value is a constant, so this calculation does not need to be repeated for every element x that is inside the quantization range; the system can perform the computation once, and store the value.

Let d be the distance between two possible values in the set of possible values that elements of the quantized tensor can take:

$$d = \frac{{q}_{max} - {q}_{min} + 1}{{2}^{n}} ,$$

where n is the number of bits used to represent the quantized elements (e.g., 8 in an 8-bit precision tensor), and 2ⁿ is the number of possible values in the set. 1 is added to the numerator because each particular possible value in the set of possible values is the center of the range of values that will be approximated using the particular possible value; therefore, the quantization range truly extends from (qₘₐₓ−½d) to (qₘₐₓ+½d) The expected value of the squared error η can be calculated by integrating the squared error over the range of values corresponding to a particular possible value in the set of possible values, and then dividing by the size of the range d:

$$η \approx Exp ( η ) = \frac{1}{d} {\int }_{x = - d / 2}^{x = d / 2} {x}^{2}$$

$$η \approx \frac{1}{d} ( \frac{1}{3} {x}^{3} {\vert}_{- d / 2}^{d / 2} )$$

$$η \approx \frac{{d}^{2}}{12}$$

$$η \approx \frac{{( {q}_{max} - {q}_{min} + 1 )}^{2}}{12 \cdot {4}^{n}}$$

Thus, the gradient of η with respect to qₘᵢₙ is:

$$\frac{Δ η}{Δ {q}_{min}} = - \frac{{q}_{max} - {q}_{min} + 1}{6 \cdot {4}^{n}}$$

The system determines (step 408) the gradient of η with respect to qₘₐₓ:

$$\frac{Δ η}{Δ {q}_{max}} = \frac{{q}_{max} - {q}_{min} + 1}{6 \cdot {4}^{n}}$$

Having computed the gradients of η according to whether the element x was above, below, or in the quantization range, the system can proceed with the process 400 using the same steps for each of the cases.

The system determines (step 408) an update to qₘᵢₙ:

$${q}_{min} ← {q}_{min} - {ϵ}_{t} \cdot \frac{Δ η}{Δ {q}_{min}} ,$$

where ϵₜ is a learning rate corresponding to the current training time step t. In some implementations, the learning rate is constant across training time steps and across different quantized neural network layers of the quantized neural network. In some other implementations, the learning rate can depend on the current training time step, the quantized neural network layer, or both.

For example, the learning rate can be proportional to a different learning rate ϵ′ that is being used to determine updates to the weight tensors of the quantized neural network. That is, the quantization ranges of the quantized neural network layer can have a learning rate ϵₜ that follows a similar pattern to the different learning rate ϵ′, e.g., by decreasing as training progresses.

As another example, the learning rate can be inversely proportional to a size of the input tensor for the quantized neural network layer. That is, as the size of the input tensor gets larger, the learning rate decreases. A larger tensor provides more samples of elements, and so it gives the opportunity for better stability and faster convergence.

The system determines (step 410) an update to qₘₐₓ:

$${q}_{max} ← {q}_{max} - {ϵ}_{t} \cdot \frac{Δ η}{Δ {q}_{max}}$$

In some implementations, the learning rates for updating qₘₐₓ and qₘᵢₙ are the same. In some other implementations, the learning rates are different.

In the implementations in which each element of the unquantized tensor has been quantized according to a different respective range of scalar values, the system can determine the update for the values qₘᵢₙ and qₘₐₓ corresponding to the element x.

In the implementations in which each element of the unquantized tensor has been quantized according to the same range of scalar values, the system can determine a combined update to the values qₘᵢₙ and qₘₐₓ by combining the updates corresponding to each element x. For example, the system can determine a sum of the respective gradients corresponding to each element x:

$${q}_{min} ← {q}_{min} - {ϵ}_{t} \cdot {\sum }_{x} {( \frac{Δη}{Δ {q}_{min}} )}_{x}$$

$${q}_{max} ← {q}_{max} - {ϵ}_{t} \cdot {\sum }_{x} {( \frac{Δη}{Δ {q}_{max}} )}_{x}$$

In the implementations in which the elements of each channel of the unquantized tensor have been quantized according to a range of scalar values corresponding to the channel, the system can determine a per-channel combined update to the values qₘᵢₙ and qₘₐₓ by combining the updates corresponding to each element x in a particular channel. For example, the system can determine a sum of the respective gradients corresponding to each element x in the particular channel:

$${q}_{min} ← {q}_{min} - {ϵ}_{t} \cdot {\sum }_{x ∈ channel} {( \frac{Δη}{Δ {q}_{min}} )}_{x}$$

$${q}_{max} ← {q}_{max} - {ϵ}_{t} \cdot {\sum }_{x ∈ channel} {( \frac{Δη}{Δ {q}_{max}} )}_{x}$$

In some implementations, the system can apply a smoothing function to the updated qₘᵢₙ and qₘₐₓ. For example, the system can apply exponential moving average smoothing to the values for qₘᵢₙ and qₘₐₓ. That is, at each time step, the system can compute initial values qₘᵢₙ^{init} and qₘₐₓ^{init} as described above, and then compute an exponential moving average of the values for qₘᵢₙ and qₘₐₓ using the i) initial computed values qₘᵢₙ^{init} and qₘₐₓ^{init} and ii) values qₘᵢₙ^{prev} and qₘₐₓ^{prev} from the previous time step:

qₘᵢₙ←α·qₘᵢₙ^{init}+(1−α)·qₘᵢₙ^{prev}

qₘₐₓ←α·qₘₐₓ^{init}+(1−α)·qₘₐₓ^{prev}

When computing the exponential moving average, the parameter a represents the degree of smoothing—a higher alpha implies more smoothing. In some implementations, the system can increase the parameter a as training progresses, so that the updates become smoother as the values for qₘᵢₙ and qₘₐₓ converge.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method of training a quantized neural network comprising, for each of a plurality of neural network layers and at each of a plurality of training time steps:

receiving an input tensor for the neural network layer;

processing the input tensor using the neural network layer to generate an output tensor, wherein the output tensor has a first precision;

obtaining a current quantization range for output tensors of the neural network layer;

processing the output tensor using the current quantization range to generate a quantized output tensor that has a second precision that is lower than the first precision;

determining an error between the output tensor and the quantized output tensor; and

determining an update to the quantization range using the determined error.

Embodiment 2 is the method of embodiment 1, wherein the quantization range for output tensors of the neural network layer is defined by a minimum scalar value and a maximum scalar value.

Embodiment 3 is the method of embodiment 1, wherein the quantization range for output tensors of the neural network layer is defined by i) a minimum tensor having a same number of elements as the output tensors of the neural network layer and ii) a maximum tensor having a same number of elements as the output tensors of the neural network layer.

Embodiment 4 is the method of embodiment 1, wherein the quantization range for output tensors of the neural network layer is defined by i) a minimum tensor having a number of elements equal to a number of channels of the output tensors and ii) a maximum tensor having a number of elements equal to the number of channels of the output tensors.

Embodiment 5 is the method of any one of embodiments 1-4, wherein determining an error between the output tensor and the quantized output tensor comprises determining, for each element of the output tensor, an element error between the element of the output tensor and the corresponding element of the quantized output tensor.

Embodiment 6 is the method of embodiment 5, wherein determining an element error of an element of the output tensor comprises:

determining whether the element is below the quantization range, above the quantization range, or in the quantization range;

if determining that the element is below the quantization range, determining the element error to be a difference between the element and a minimum value of the quantization range;

if determining that the element is above the quantization range, determining the element error to be difference between the element and a maximum value of the quantization range;

if determining that the element is in the quantization range, determining the element error to be an average element error for elements evenly distributed in the quantization range.

Embodiment 7 is the method of any one of embodiments 1-6, wherein processing the input tensor using the neural network layer comprises:

obtaining a weight tensor for the neural network layer, wherein the weight tensor has the first precision;

determining a minimum weight value and a maximum weight value for elements of the weight tensor;

processing the weight tensor using the minimum weight value and the maximum weight value to generate a quantized weight tensor that has the second precision;

processing the input tensor and the quantized weight tensor to generate the output tensor.

Embodiment 8 is the method of any one of embodiments 1-7, wherein determining an update to the quantization range using the determined error comprises determining the update using gradient descent.

Embodiment 9 is the method of embodiment 8, wherein a learning rate for determining the update to the quantization range is proportional to a learning rate for determining an update to a weight tensor of the neural network layer.

Embodiment 10 is the method of any one of embodiments 8 or 9, wherein a learning rate for determining the update to the quantization range is inversely proportional to a size of the input tensor for the neural network layer.

Embodiment 11 is the method of any one of embodiments 1-10, wherein determining an update to the quantization range using the determined error comprises determining the update using exponential moving average smoothing.

Embodiment 12 is a system comprising: one or more computers and one or more storage devices storing instructions that are operable, when executed by the one or more computers, to cause the one or more computers to perform the method of any one of embodiments 1 to 11.

Embodiment 13 is a computer storage medium encoded with a computer program, the program comprising instructions that are operable, when executed by data processing apparatus, to cause the data processing apparatus to perform the method of any one of embodiments 1 to 11.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a quantized neural network comprising, for each of a plurality of neural network layers and at each of a plurality of training time steps:
receiving an input tensor for the neural network layer;
processing the input tensor using the neural network layer to generate an output tensor, wherein the output tensor has a first precision;
obtaining a current quantization range for output tensors of the neural network layer;
processing the output tensor using the current quantization range to generate a quantized output tensor that has a second precision that is lower than the first precision;
determining an error between the output tensor and the quantized output tensor; and
determining an update to the quantization range using the determined error.

2. The method of claim 1, wherein the quantization range for output tensors of the neural network layer is defined by a minimum scalar value and a maximum scalar value.

3. The method of claim 1, wherein the quantization range for output tensors of the neural network layer is defined by i) a minimum tensor having a same number of elements as the output tensors of the neural network layer and ii) a maximum tensor having a same number of elements as the output tensors of the neural network layer.

4. The method of claim 1, wherein the quantization range for output tensors of the neural network layer is defined by i) a minimum tensor having a number of elements equal to a number of channels of the output tensors and ii) a maximum tensor having a number of elements equal to the number of channels of the output tensors.

5. The method of claim 1, wherein determining an error between the output tensor and the quantized output tensor comprises determining, for each element of the output tensor, an element error between the element of the output tensor and the corresponding element of the quantized output tensor.

6. The method of claim 5, wherein determining an element error of an element of the output tensor comprises:
determining whether the element is below the quantization range, above the quantization range, or in the quantization range;
if determining that the element is below the quantization range, determining the element error to be a difference between the element and a minimum value of the quantization range;
if determining that the element is above the quantization range, determining the element error to be difference between the element and a maximum value of the quantization range;
if determining that the element is in the quantization range, determining the element error to be an average element error for elements evenly distributed in the quantization range.

7. The method of claim 1, wherein processing the input tensor using the neural network layer comprises:
obtaining a weight tensor for the neural network layer, wherein the weight tensor has the first precision;
determining a minimum weight value and a maximum weight value for elements of the weight tensor;
processing the weight tensor using the minimum weight value and the maximum weight value to generate a quantized weight tensor that has the second precision;
processing the input tensor and the quantized weight tensor to generate the output tensor.

8. The method of claim 1, wherein determining an update to the quantization range using the determined error comprises determining the update using gradient descent.

9. The method of claim 8, wherein a learning rate for determining the update to the quantization range is proportional to a learning rate for determining an update to a weight tensor of the neural network layer.

10. The method of claim 8, wherein a learning rate for determining the update to the quantization range is inversely proportional to a size of the input tensor for the neural network layer.

11. The method of claim 1, wherein determining an update to the quantization range using the determined error comprises determining the update using exponential moving average smoothing.

12. A system comprising one or more computers and one or more storage devices storing instructions that are operable, when executed by the one or more computers, to cause the one or more computers to perform operations for training a quantized neural network, the operations comprising, for each of a plurality of neural network layers and at each of a plurality of training time steps:
receiving an input tensor for the neural network layer;
processing the input tensor using the neural network layer to generate an output tensor, wherein the output tensor has a first precision;
obtaining a current quantization range for output tensors of the neural network layer;
processing the output tensor using the current quantization range to generate a quantized output tensor that has a second precision that is lower than the first precision;
determining an error between the output tensor and the quantized output tensor; and
determining an update to the quantization range using the determined error.

13. The system of claim 12, wherein the quantization range for output tensors of the neural network layer is defined by a minimum scalar value and a maximum scalar value.

14. The system of claim 12, wherein the quantization range for output tensors of the neural network layer is defined by i) a minimum tensor having a same number of elements as the output tensors of the neural network layer and ii) a maximum tensor having a same number of elements as the output tensors of the neural network layer.

15. The system of claim 12, wherein the quantization range for output tensors of the neural network layer is defined by i) a minimum tensor having a number of elements equal to a number of channels of the output tensors and ii) a maximum tensor having a number of elements equal to the number of channels of the output tensors.

16. The system of claim 12, wherein determining an error between the output tensor and the quantized output tensor comprises determining, for each element of the output tensor, an element error between the element of the output tensor and the corresponding element of the quantized output tensor.

17. One or more non-transitory computer storage media encoded with computer program instructions that when executed by a plurality of computers cause the plurality of computers to perform operations for training a quantized neural network, the operations comprising, for each of a plurality of neural network layers and at each of a plurality of training time steps:
receiving an input tensor for the neural network layer;
processing the input tensor using the neural network layer to generate an output tensor, wherein the output tensor has a first precision;
obtaining a current quantization range for output tensors of the neural network layer;
processing the output tensor using the current quantization range to generate a quantized output tensor that has a second precision that is lower than the first precision;
determining an error between the output tensor and the quantized output tensor; and
determining an update to the quantization range using the determined error.

18. The non-transitory computer storage media of claim 17, wherein the quantization range for output tensors of the neural network layer is defined by a minimum scalar value and a maximum scalar value.

19. The non-transitory computer storage media of claim 17, wherein the quantization range for output tensors of the neural network layer is defined by i) a minimum tensor having a same number of elements as the output tensors of the neural network layer and ii) a maximum tensor having a same number of elements as the output tensors of the neural network layer.

20. The non-transitory computer storage media of claim 17, wherein the quantization range for output tensors of the neural network layer is defined by i) a minimum tensor having a number of elements equal to a number of channels of the output tensors and ii) a maximum tensor having a number of elements equal to the number of channels of the output tensors.
